(19) United States
(12) Patent Application Publication
(10) Pub. No.: US 2005/0099796 A1
(43) Pub. Date: May 12, 2005

(54) Portable illumination systems and methods of use

(76) Inventor: Bryan Magee, Indianapolis, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/912,255

(22) Filed: Aug. 5, 2004

Related U.S. Application Data
(60) Provisional application No. 60/492,649, filed on Aug. 5, 2003.

(51) Int. Cl. F21V 21/08

(52) U.S. Cl. 362/103

(57) ABSTRACT

A set of relatively small-sized devices is disclosed for safety and/or illuminative lighting in conjunction with a horse or similar animal, or with equipment associated with such an animal or with transportation devices for individuals. The devices include high-intensity light-emitting diodes (LEDs), which provide intense, high visible light while being lightweight and giving off little heat. Batteries and wiring are also provided, and are included within structure that are easily attached to and usable from tack such as stirrups, saddles, or harnesses, or easily attached to parts of bicycles or other person transportation.

### FIELD OF THE INVENTION

The present invention is directed generally to portable, high-intensity illumination systems, and more particularly to a light source that is easily carried by or attached to a body and using a light emitting diode (“LED”).

### BACKGROUND OF THE INVENTION

Conventional portable illumination systems, such as flashlights, include an incandescent light bulb and conventional dry cell batteries enclosed in a housing typically constructed of a body section and a head section. The portable, illumination systems of this type are often bulky and cumbersome, and thus often are not carried on or held by a person, or are not easily attached to the body. Further, flashlights or other illuminators that are easily carried in the hand frequently do not provide a high-intensity and/or long-lasting light. Rather, they are generally used for emergency situations or those in which light is needed for a short period or for illumination over a relatively short distance.

There have been some variations on portable, hands-free illumination systems. Underground coal miners have long mounted large conventional incandescent lights with large, heavy battery packs to the front of hard hats, allowing them to work with both hands while the light on the hat illuminated the area in front of them. U.S. Pat. No. 3,032,647 to Wansky provides an example of a hat-mounted light. U.S. Pat. No. 4,616,297 to Liu also provides an example of a hands-free flashlight, which mounts conventional incandescent light bulbs and conventional drycell batteries to a bulky frame to be worn like spectacles. U.S. Pat. No. 5,217,294 to Liston and U.S. Pat. No. 5,412,545 to Rising describe hands-free operation of a conventional flashlight by strapping the flashlight to the user's head.

While any of these devices, if worn by a user, might function as a hands-free illumination device, such devices are even more bulky and cumbersome than conventional flashlights. Moreover, such devices are not generally suitable for use in conjunction with other equipment, such as that used by public safety personnel.

Conventional hands-free portable illumination systems are bulky primarily because they use incandescent light bulbs, which suffer from poor efficiency in converting electrical power into radiated visible light. Most of the electrical energy incandescent light bulbs consume is wasted in the form of heat energy, while less than 7% of the energy they consume is typically radiated as visible light. This has severe negative consequences for portable illuminator applications, such as hands-free illumination devices, where the amount of power available for lighting systems is limited. In these applications, electrical power is usually provided by batteries which are periodically replaced, as in the case of a flashlight. Such a mechanism for providing electrical power is inherently bulky, heavy, and/or expensive due at least in part to poor power-conversion efficiency in generating visible light.

As already noted, incandescent lamps generate large amounts of heat for an equivalent amount of generated light as compared to other sources. This results in very high bulb-wall temperatures typically in excess of 250 degrees Celsius and large heat accumulations which must be dissipated properly by radiation, convection, or conduction to prevent damage or destruction to the illuminator support members, enclosure, optics or to other nearby components. Providing room for the necessary heat dissipation requires additional bulkiness. This high heat signature of common incandescent light sources in illuminators is particularly problematic for hands-free light sources, where the light source is in close proximity to the user's body or equipment.

Incandescent light bulbs, or lamps, are also disadvantageous because they are fragile and have a short life. Even in stable environments incandescent lamps must be replaced frequently, sometimes at great inconvenience, hazard, and/or expense. In addition to their short life, incandescent lamps are susceptible to damage from mechanical shock and/or vibration. Such occurrences can damage the delicate filaments from which incandescent light emissions originate, or can damage the surrounding glass casing, which can result in air entering the casing and quick burning out of the filament. Incandescent lamps can also be easily damaged by exposure to liquid moisture, due to the thermo-mechanical stress associated with contact between the hot glass bulb wall and cooler fluids. Thus, incorporating an incandescent lamp into a hands-free illumination device requires substantial or extreme measures to protect the light bulb from shock, vibration, moisture and other hazards while still allowing for removal of the bulb or light fixture when it burns out, is permanently damaged or otherwise loses power.

Incandescent light bulbs or lamps also exhibit certain electrical characteristics which make them inherently difficult to incorporate in small, lightweight applications, like hands-free illumination devices. For instance, when an incandescent light source is first energized by a voltage source, there is an initial surge of current which flows into the filament. This inrush current, which is typically 12 to 20 times the normal operating current, limits the lifetime of the lamp thus further amplifying the need for an illuminator structure which allows for frequent replacement. Inrush current also necessitates unusual consideration when designing supporting electrical circuits which contain them. Fuses, relays, mechanical or electronic switches, wire harnesses, and connectors electrically connected to such lamps must be capable of repeatedly carrying this extreme transient.

In addition, the voltage-current (V-I) characteristic of incandescent lamps is notoriously non-linear, as are each of the relationships between light output and voltage, current, or power. The luminous intensity, color temperature, and service life of incandescent lamps varies exponentially as a function of applied current or voltage. This sensitivity to power source variation makes electronic control of incandescent lamps a particularly difficult problem. They are further susceptible to significant reliability and field service life degradation when subjected continuously to DC electrical power, pulse-width modulated DC power, simple on/off switching of any sort, or any over-voltage conditions, however minor. Incandescent lamps also possess significant inductance which, when combined with their relatively high current load, complicates electronic switching and control greatly due to inductive resonant voltage transients.

These disadvantages to incandescent bulbs in general, and standard flashlights in particular, mean that bright, visible lighting is not generally carried by riders of horses or other animals or individual conveyances. A need exists for lighting that can be carried by animals, small modes of conveyance or people, such as those involved in public safety work, to improve their visibility and safety.

### SUMMARY OF THE INVENTION

Light emitting diodes (“LEDs”) are provided as a light source for use in lighting devices for illumination or safety for connection or attachment to a person, animal or associated equipment. Embodiments include a lighting device using LED technology is provided in the form of an attachment to a horse's tack, such as a stirrup or saddle, to mark the horse and rider and warn passers-by of their presence. In another embodiment, a lighted cuff or strap is provided for wrapping around a person's or animal's extremity. Features including switching between high- and low-intensity light, flashing or blinking lights, and use of different colors of light are also disclosed.

Unlike conventional incandescent light bulbs/lamps, LEDs are highly efficient, in that most of the power consumed by an LED is converted into visible light. The efficiency of LEDs allows them to be incorporated into compact, streamlined designs with smaller and lighter batteries or other power sources. Further, LEDs are highly shock resistant and therefore provide significant advantages over incandescent and fluorescent bulbs, rendering LEDs ideal for critical applications, such as pilot-mounted aircraft cockpit illumination. LEDs possess operating lifetimes from 200,000 hours to 1,000,000 hours, as compared to the typical 1,000 to 2,000 hours for incandescent lamps. Finally, LEDs avoid the transience and inductance problems associated with incandescent lamps, allowing LEDs to be incorporated into various structures using simple circuitry.

Until recently, LEDs did not produce enough light to illuminate another surface. Thus, most LEDs were used as display devices, for example, on/off indicators, etc. These uses still dominate the LED market, but recent advances in LED materials, design and manufacturing have resulted in significant increases in LED luminous efficacy and, in their most recent commercial forms, exhibit a higher luminous efficacy than incandescent lights. Thus, the latest LEDs can provide as much illumination as conventional incandescent lamps.

In several embodiments of the invention, an apparatus is provided including one or more high-intensity LEDs fixed in a box that is attachable to a horse's equipment, such as stirrup or saddle, or to parts of other conveyances or equipment, such as bicycles. In this embodiment, the LEDs may receive power from one or more batteries within the box, which may be rechargeable via a connection to the box from an external power source. In another embodiment, a cuff having LEDs and a power source is provided for wrapping around a horse's or person's leg, or a part of associated equipment. In these embodiments, the LEDs may be controlled by one or more switches that can be either integrated with the box, cuff or other LED holder, or can be remote and attached by a cable. A user (e.g., a horse rider) can cause the LEDs to illuminate in static and/or dynamic (flashing) fashion by actuating the switch. The LEDs are preferably oriented to direct the LEDs' luminance forward, backward and/or to the side so as to illuminate the area of interest or to advise passers-by of the presence of horse, rider, and/or equipment. LEDs of various colors may be used, with or without appropriate covers or lenses, to produce, for instance, white, blue, red, yellow or green light. Transparent or translucent covers with or without wording or other characters or symbols may also be used. Methods of using and installing the disclosed devices are also provided.

### BRIEF DESCRIPTION OF THE DRAWINGS

FIG. 1A is a side exploded view of an embodiment of a lighting device attachable to horse tack.

FIG. 1B is a schematic view of the embodiment shown in FIG. 1A.

FIG. 1C is a side view of a stirrup, with which the embodiment shown in FIG. 1A can be used.

FIG. 1D is a side view of a stirrup with the embodiment shown in FIG. 1A attached.

FIG. 1E is a schematic diagram of a circuit that may be used in one or more of the disclosed device embodiments.

FIG. 2A is a schematic internal view of a further embodiment of a lighting device.

FIG. 2B is a front view of the embodiment of FIG. 2A

FIG. 2C is a further front view of the embodiment of FIG. 2A.

FIG. 3A is a front view of a further embodiment of a lighting device.

FIG. 3B is a top internal schematic view of the embodiment of FIG. 3A.

FIG. 3C is a top internal schematic view of a variation of the embodiment of FIG. 3A.

FIG. 3D is a rear view of the embodiment of FIG. 3A.

FIG. 3E is a front view of a prototype substantially according to the embodiment of FIG. 3A.

FIG. 4A is a top view of a further embodiment of a lighting device.

FIG. 4B is a schematic view of the embodiment of FIG. 4A.

FIG. 5A is a schematic view of a further embodiment of a lighting device.

FIG. 5B is a front view of the embodiment of FIG. 5A.

FIG. 6A is a front perspective view of another embodiment of a lighting device.

FIG. 6B is a rear perspective view of the embodiment of FIG. 6A.

FIG. 6C is a schematic representation of wiring for the embodiment of FIG. 6A.

FIG. 6D is a side view of the embodiment shown in FIG. 6A along with a stirrup.

FIG. 6E is a schematic diagram of a circuit that may be used in one or more of the disclosed device embodiments.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein, being contemplated as would normally occur to one skilled in the art to which the invention relates.

The present invention is primarily directed to portable, lightweight, high-intensity illumination devices utilizing LEDs, and is described below primarily in a context of illumination devices used in conjunction with public safety, e.g. for hand held use by police officers or for attachment to police vehicles or horses. However, it will be appreciated that embodiments of the invention may be used for other purposes or situations or in other fields in which such lighting is necessary or should be connected, or alternative embodiments may be made for such purposes, fields or situations.

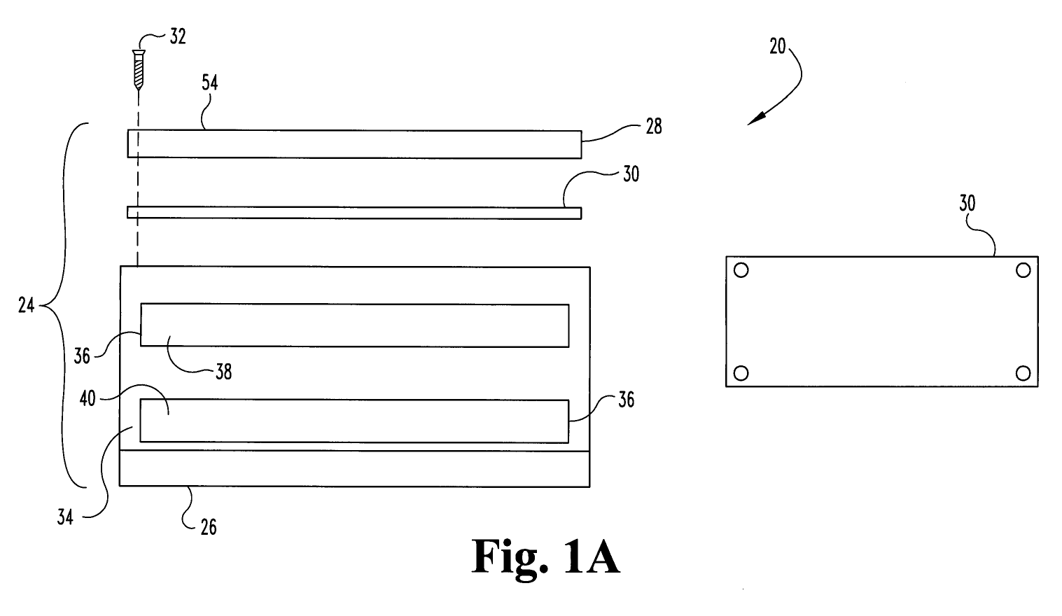

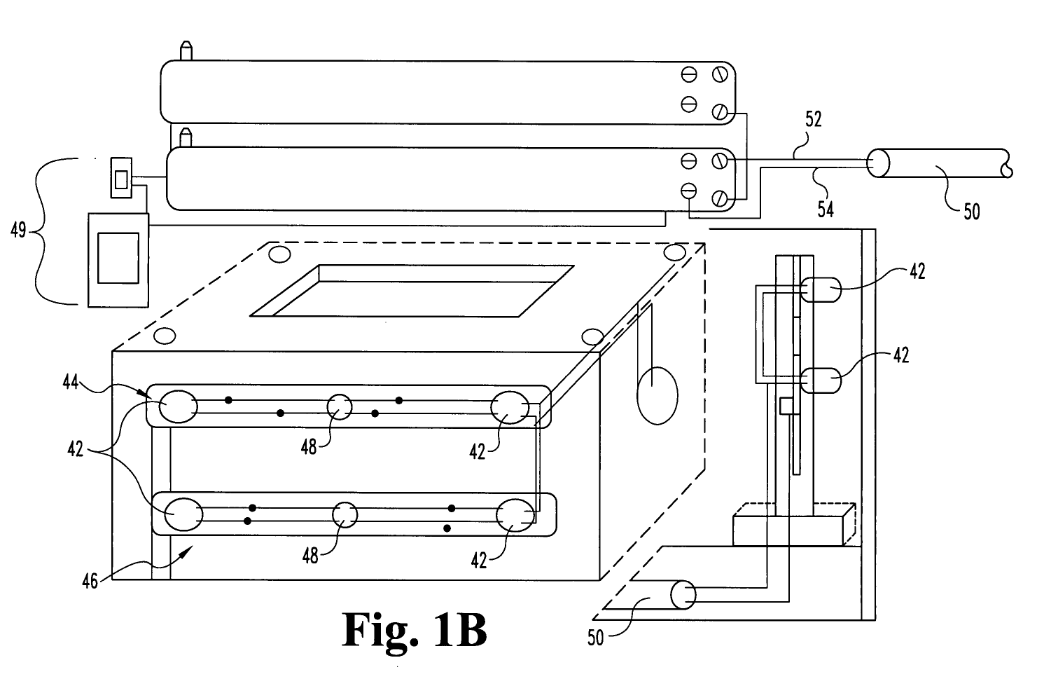

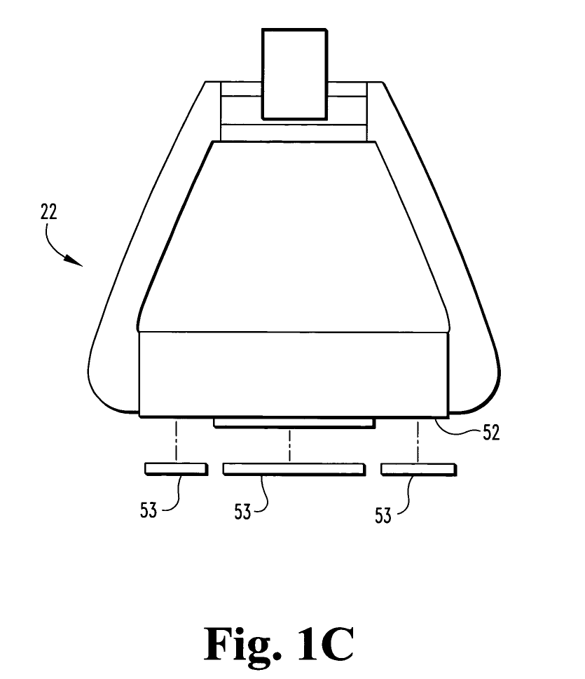

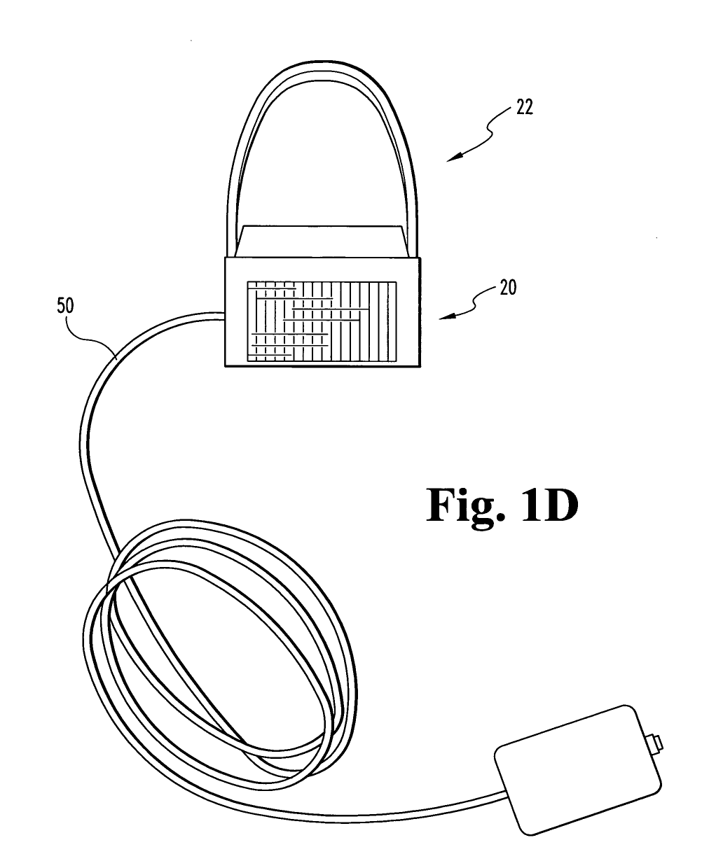

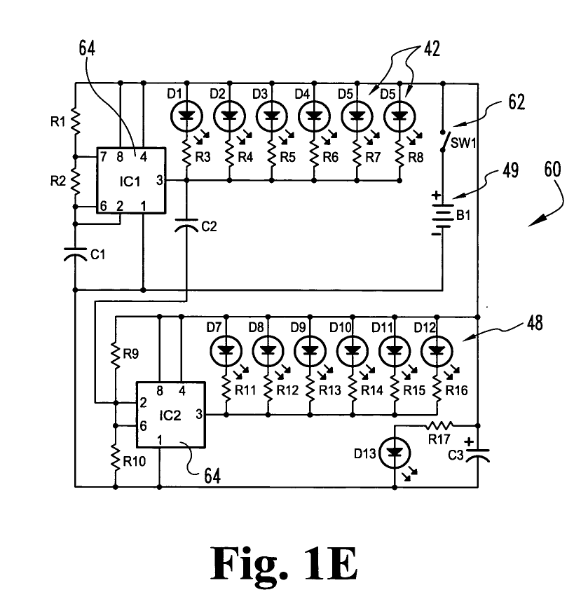

Referring now generally to FIGS. 1A-1D, there is shown a first embodiment of a lighting system for use on a horse, such as a horse ridden by a police officer or other public safety official. Throughout this specification, reference may be made to uses of the devices and systems described herein with “horses,” and it is intended that such uses extend to other beasts of burden or machines to be ridden by individuals (all of which may be referred to, among other things, by the term “conveyance”). In FIGS. 1A-1D, there is shown a lighting system 20 for attachment to a stirrup 22, such as a stirrup forming part of the equipment for riding a horse. The exterior of system 20 features a box 24 or similar container. Box 24 includes a battery compartment 26, which is shown at the bottom of box 24 for ease of access, but may be placed in various places on box 24. A top 28 is secured to box 24, and a seal 30 is preferably placed between top 28 and box 24. Seal 30 may be made of rubber or other known natural or synthetic materials, and in one specific embodiment forms an all-weather seal. In one embodiment, top 28 and seal 30 are secured to box 24 via one or more screws 32, and in one specific embodiment four screws 32 are placed through top 28 and seal 30 and into box 24, preferably at each corner of top 28, seal 30 and box 24.

In one particular embodiment, box 24 and top 28 are made of or covered in a shiny material. For example, box 24 and top 28 may be made of chrome or other shiny metal, or may be covered by an outer layer of shiny or reflective paper, foil, tape, paint or other material.

Box 24 further includes a front side 34 and a backside (not shown). Front side 34 includes, in the illustrated embodiment, two elongated holes 36, in which are set lenses 38 and 40. Lenses 38 and 40 are preferably colored. For example, lens 38 may be red and lens 40 may be blue, in conformance with common or standard light colors used by police departments and other public safety officials. The illustrated embodiment shows holes 36 and lenses 38 and 40 as rectangular and extending along a substantial part of the length of side 34 of box 24. It will be understood, however, that smaller or differently-shaped holes 36, or more than two holes 36, may be placed in front side 34, all or some of which may be covered by or otherwise associated with one or more internal and/or external colored lenses.

Within box 24, and proximate to lenses 38 and 40, there are placed sets of light emitting diodes (LEDs) 42. An upper set 44 of LEDs 42 corresponds to lens 38 and its corresponding hole 36, while a lower set 46 of LEDs 42 corresponds to lens 40 and its corresponding hole 36. In the illustrated embodiment, three LEDs 42 are provided in each set 42 and 44. In the embodiment in which lenses 38 and 40 are colored, LEDs 42 may be white, and in one embodiment may be extra bright lamps (catalog number XPR102 272-11881). Alternatively, LEDs 42 may be of the same color as the lens (if any) with which they correspond. For example, if lens 38 has a red color, the LEDs 42 associated with lens 38 may also be red in color, and in one embodiment could be 1.7 volt high bright red LEDs. In yet another embodiment, lens 38 and/or 40 may be clear (i.e. transparent, translucent, or otherwise having no color), and the LEDs associated with them may be colored red, blue, or another color as appropriate to the use. In another embodiment, sets 44 and 46 of LEDs 42 each include five LEDs 42 for providing high-intensity light, and further LEDs 48 for use when the high-intensity light is not needed. For example, in the case in which a mounted police officer is stopped in an investigation, the high-intensity LEDs 42 may be turned on to alert passers-by to the presence of the officer and his or her horse, in much the same way that flashers or rolling lights are activated on public safety automobiles that are parked during an investigation. When the investigation is over, the mounted police officer can turn off the high intensity LEDs 42, and turn on LEDs 48 to provide some lower-intensity running lights on his or her horse.

Standard methods, devices and materials are used for wiring and connecting LEDs 42 (and 48, if present). A cable 50 is provided to connect LEDs 42 (and 48, if provided) in box 24 to a switch (not shown). Cable 50 includes wires 52 and 54 to connect LEDs 42 and/or 48 to the switch. An opening with a rubber or other seal 55 may be provided in box 24 to allow cable 50 to be electrically connected to items in box 24. Cable 50 is preferably long enough to reach from stirrup 22 to a saddle horn (not shown) upon the horse, or other position on the saddle, riding tack or the animal itself that would be convenient for a rider to make use of it.

Battery compartment 26, as noted above, is located in or attached to the bottom of box 24, in one embodiment. Battery compartment 26 includes standard holders and/or attachments for batteries, to enable the current from one or more batteries to be used to power LEDs 42 and/or 48. In one particular embodiment, battery compartment 26 is sized and equipped to hold three AA batteries and one type 23-154 12-volt battery (shown schematically at 49). In that embodiment, the 12-volt battery is connected to LEDs 42, and provides the power to enable LEDs 42 to provide high-intensity light. The three AA batteries are connected to LEDs 48 to provide for lower-intensity running lights when LEDs 42 are not on and such running-light illumination is necessary. As shown in FIG. 1C, stirrup 22 has a generally flat bottom surface 52, and in one embodiment hook-and-loop fastener 53 such as that sold under the trademark VELCRO® is attached to bottom surface 52. Corresponding pieces of hook-and-loop fastener are attached to a top surface 54 of box top 28. It is preferred that high-quality hook-and-loop fastener intended for industrial use be used. In this way, system 20 is attached to the underside 52 of stirrup 22, and is held there while the horse walks around. Cable 50 is preferably held on or close to stirrup 22, the straps or other connections that connect stirrup 22 to a saddle (not shown), and the saddle itself to connect to the switch that is located on or near the saddle.

Preferably the switch has an “off” setting, and at least two “on” settings. One “on” setting causes LEDs 42 to illuminate and another “on” setting causes LEDs 48 only to illuminate. A third “on” setting may be provided to enable LEDs 42 and/or 48 to flash or turn on and off in a given sequence, assuming LEDs 42 and/or 48 are wired appropriately as is well known in the art.

A schematic diagram of one embodiment of a circuit 60 that can be used is also shown. It indicates LEDs 42 and 48, battery 49, switch 62, integrated circuits 64, capacitors (shown as C1 through C3) and resistance (shown as R1 through R17). As indicated above, these and other components may be used in known fashion in order to provide energy for substantially continuous illumination or flashing operation, or other operation of LEDs 42 and/or 48.

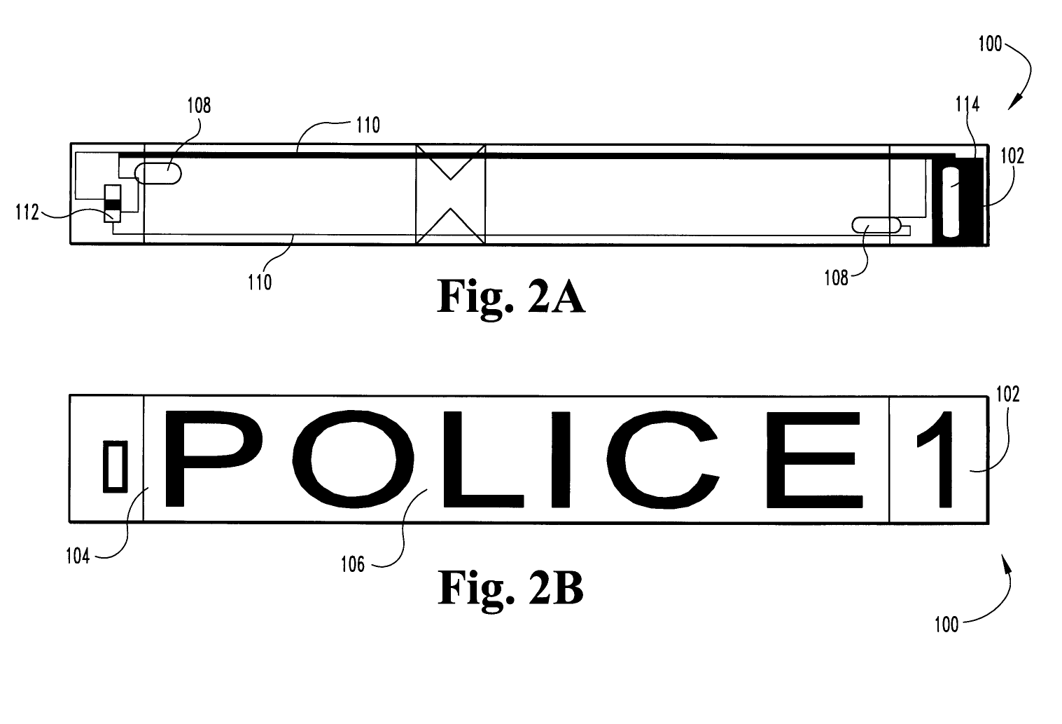

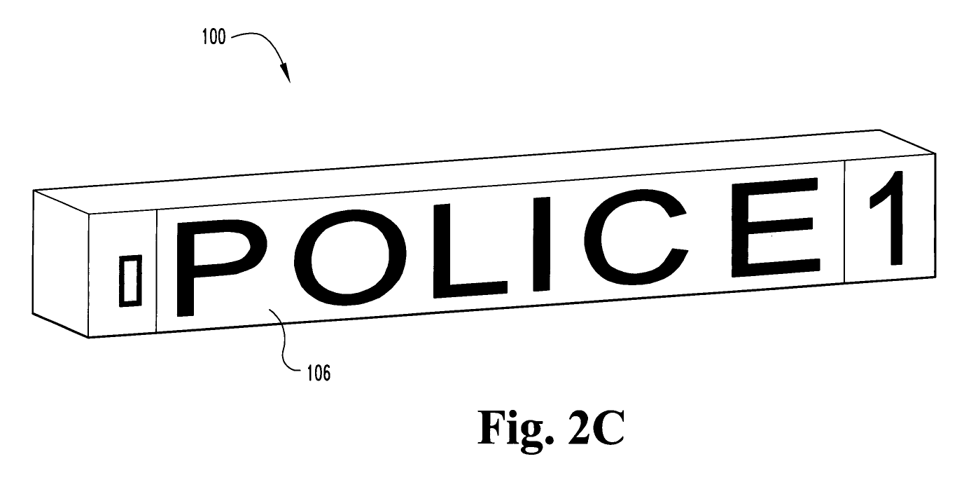

Referring now to FIGS. 2A-2C, there is shown a high-intensity light 100 intended for mounting to the rear of a saddle on a horse or other mode of individual transportation, including use on such items employed by police or other public-safety officers. Light 100 includes a box 102, having a front side 104, in which is placed a clear lens or sign 106. In the illustrated embodiment, lens or sign 106 features the word “POLICE,” and thus light 100 is intended for use on a police animal or equipment. A set of high bright LEDs 108 are placed within box 102. In the illustrated embodiment two LEDs 108 are included, and are placed toward opposite ends of box 102. LEDs 108 are connected by wires 110 to a switch 112 and a battery 114, in a fashion known in the art. Switch 112 is a standard, two-position on/off switch. In a preferred embodiment, battery 114 is a type 23-154 12-volt battery. Light 100 is intended to be small enough to be carried on an officer's person, or among his or her equipment, or attached to a saddle or other equipment associated with the officer or an animal or device he or she has. It will be understood that light 100 may be attached to saddle, equipment, or other surfaces via hook-and-loop fastener as generally described above, or by adhesive, clips, hooks, snaps or other known attaching devices.

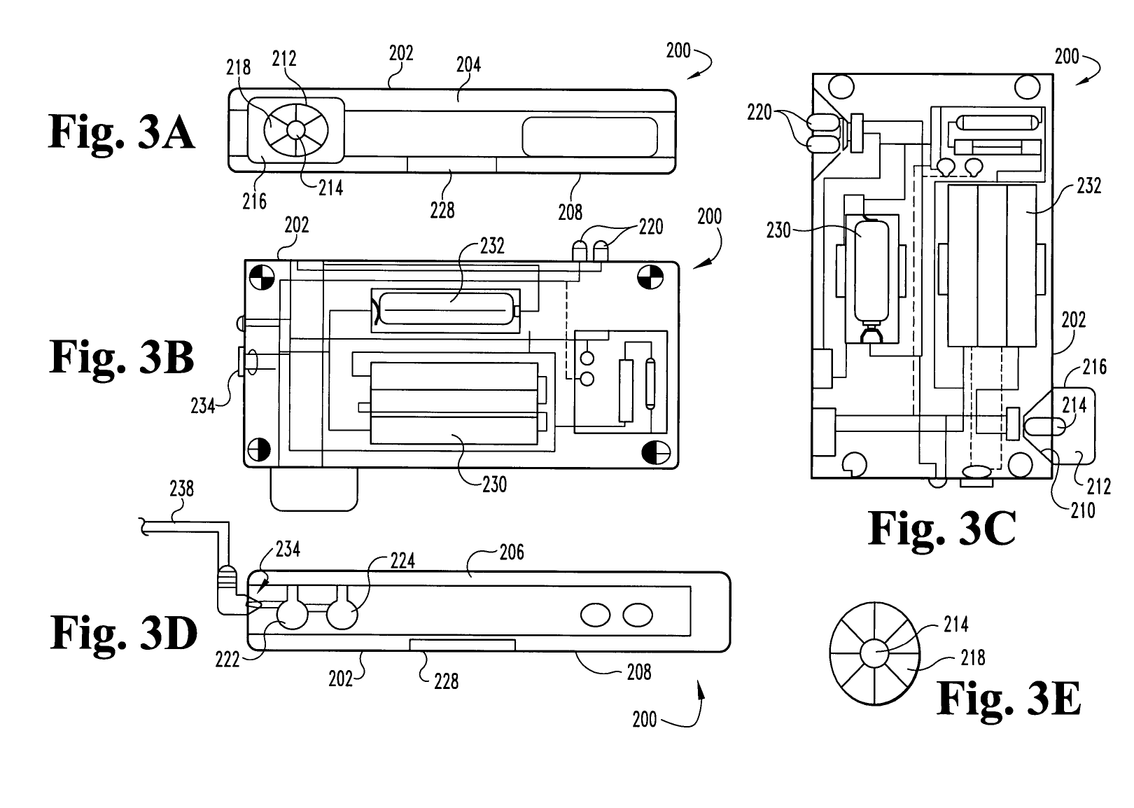

Referring now to FIGS. 3A-3D, a portable lighting system 200 is shown. System 200 provides a forward-pointing, high-intensity white light, and a rearward-pointing, high-intensity red light, and therefore may be used to mark a horse or device or other equipment in much the same way as an automobile is commonly marked, i.e. with white light pointing forward and red light facing backward.

System 200 includes a box 202 with a front side 204, a rear side 206, and a bottom side 208. Front side 204 includes an opening 210 in which a light fixture 212 is situated. Light fixture 212 includes a high-intensity LED 214 and a casing 216. LED 214 may be wired to shine continuously, and/or to operate in strobe fashion. Casing 216 includes an internal surface or surfaces 218 that are reflective and operate to intensify and direct the light from LED 214 into a beam emitted from front side 204 of system 200.

Rear side 206 of system 200 includes two high-intensity red LEDs 220. Rearward-facing side 206 also includes two on/off switches 222 and 224 in the illustrated embodiment. In one embodiment, switch 222 may operate white LED 214, while switch 224 may operate red LEDs 220. Bottom surface 210 further features a slot 228 in which a strap, tab, catch or similar structure (not shown) can be fitted to secure system 200 to a horse or a piece of equipment. Alternatively, a piece of hook-and-loop fastener may be fitted into slot 228, and a mating piece of hook-and-loop fastener attached to a piece of equipment, so that system 200 can be easily attached and removed to such a piece of equipment.

Inside box 202, standard electrical wiring and equipment is found, including eight AA batteries and standard holders for them, and two AAA batteries and standard holders for them (schematically shown at 230 and 232, respectively). The AA batteries are connected to light fixture 210 and switch 222 in a known fashion, and the AAA batteries are connected to red LEDs 220 and switch 224, also in a known fashion. In one specific embodiment, a connection 234 is provided along the side of box 202 for a plug 236. Plug 236 is connected by a cable 238 to a hand switch (not shown). Connection 234 is electrically connected to one or both of switches 222 and 224. In this way, system 200 can be remotely operated by a hand switch connected via cable 238 and plug 236 to system 200.

As with many of the other embodiments described herein, a particular embodiment of system 200 is intended to be relatively small, for example for attachment to a police officer's horse or for carrying on a police officer's person. Accordingly, one preferred embodiment has dimensions of approximately four inches in length (i.e. across front side 204), a width of approximately two inches (across a left or right side of box 202), and a height of about one inch (i.e. from a top surface of box 202 to bottom surface 208).

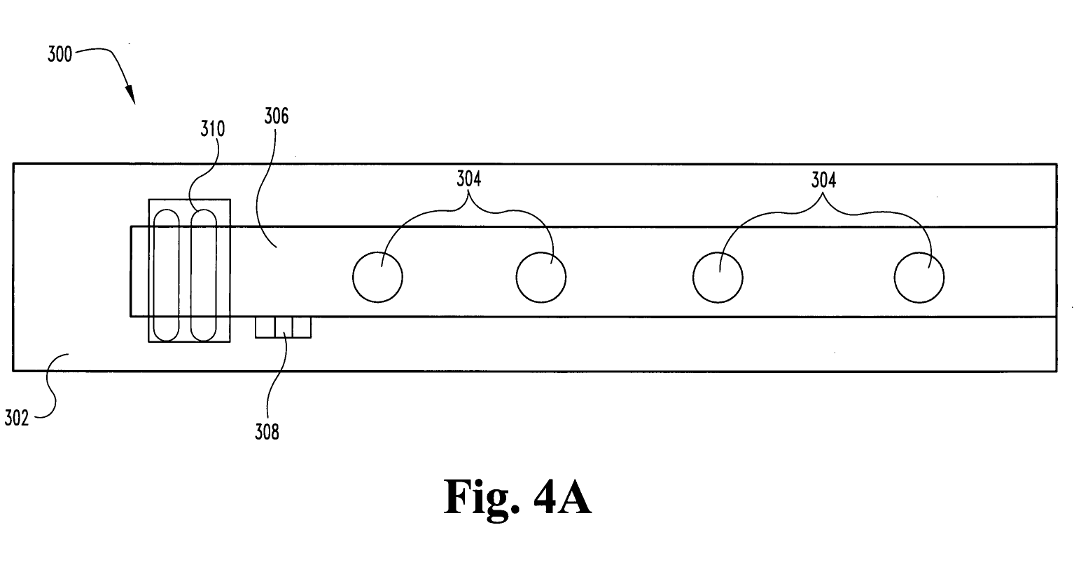

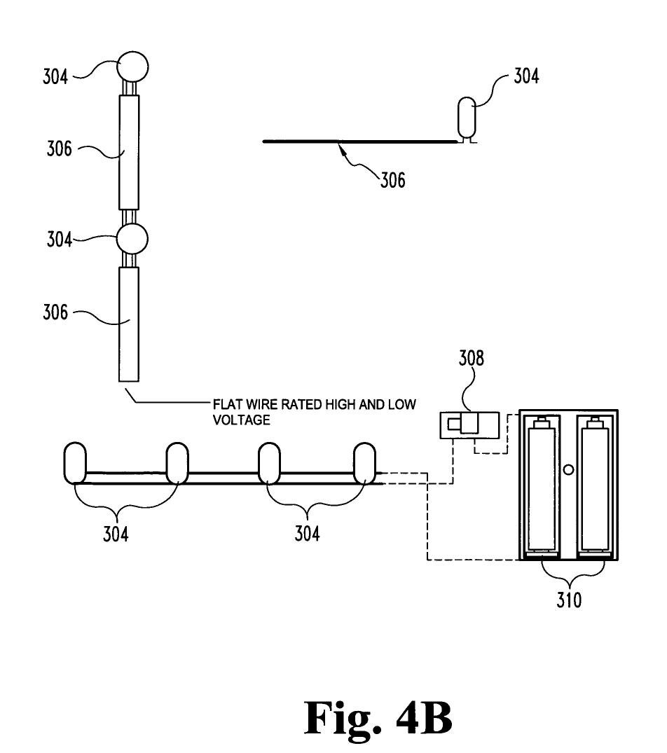

Referring now to FIGS. 4A-4B, there is shown an embodiment of a safety and/or illumination lighting system 300. System 300 includes a cuff 302, and a set of high-intensity red LEDs 304 attached to cuff 302. Cuff 302, in one embodiment, is a linear piece of flexible material, such as leather, certain plastics, or other natural or synthetic non-woven or woven materials, formed into a circle with its ends attached to each other. Each end of the linear flexible material used to make cuff 302 may be provided with known structure for attaching the ends to each other, such as clips, hook-and-loop fastener material, buckles, snaps, clasps, zippers, or other such structures. Cuff 302 is of a length and width to fit around the ankle or hoof of a horse, an ankle or foot covering of a rider, or in similar fashion to another part of horse, machine, or rider to provide light for safety or illumination, without impeding the walking or other motion of the horse, rider or machine.

LEDs 304 (of which there are four in the illustrated embodiment) are attached to an elongated flexible electrical connector material 306. In one embodiment, material 306 includes a plastic or other suitable non-conducting substrate to which flexible wires are attached or embedded, which wires extend to connections or clips for LEDs 304. The substrate is then attached to cuff 302 in a known fashion, for example by adhesive, by sewing, by hook-and-loop fastener, or the like. LEDs 304 are electrically connected via an on/off switch 308 to a set of AAA batteries 310, in the illustrated embodiment. Batteries 310 and their holders are attached to cuff 302 on either the inside or outside of cuff 302. Batteries 310 and their holders are contained in a closeable box or pouch (not shown) as is known in the art, to prevent batteries 310 from coming loose and rendering system 300 temporarily useless.

Variations on the above-described embodiment of system 300 are within the scope of the present invention. For example, one or more high intensity white LEDs may replace the same number of red LEDs, or while LEDs may be added to connector material 306 in a location such that white LEDs generally face forward when system 300 is placed on a horse. In such a case, switch 308 may be replaced with a switch having multiple “on” positions for lighting different combinations of LEDs. It will be appreciated by one skilled in the art that if the latter type of switch is provided, additional wiring will be necessary to connect the additional “on” positions in the switch. As with other embodiments described herein, wiring, connections and switch(es) can be provided to allow one or more LEDs to blink in order to increase perception of the lights.

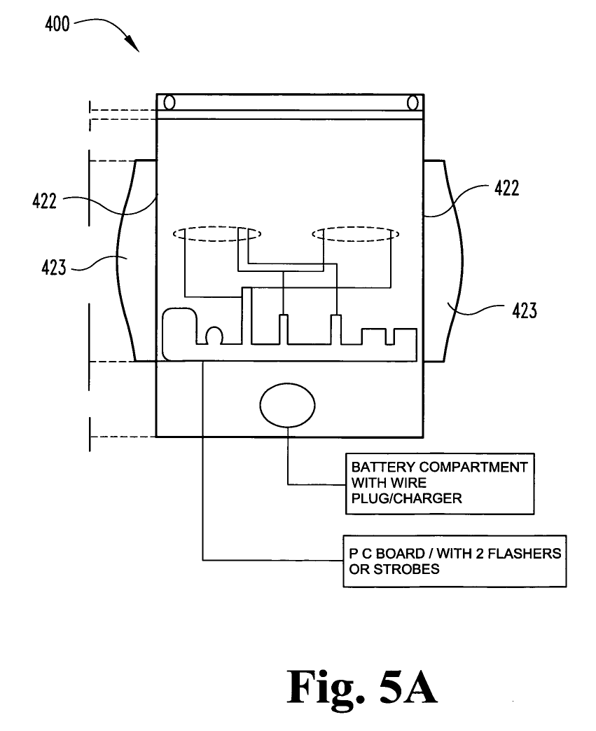

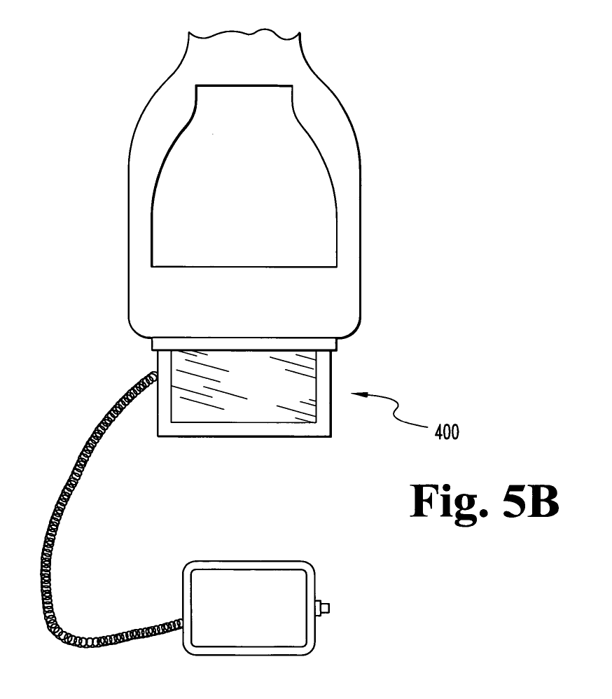

Referring now to FIGS. 5A-5B, there is shown a variation of the embodiment of the device shown in FIGS. 1A-1D. The principal difference between this and system 20 is that system 400 is provided with one or more side openings 422 featuring a reflective, transparent or translucent yellow or white lens 423 on each side and a white high-intensity LED is placed proximate to each lens to provide light for safety and/or illumination. A printed circuit board provided in the system 400 can allow flashing or strobe action of the LEDs, for greater visibility when safety is the issue.

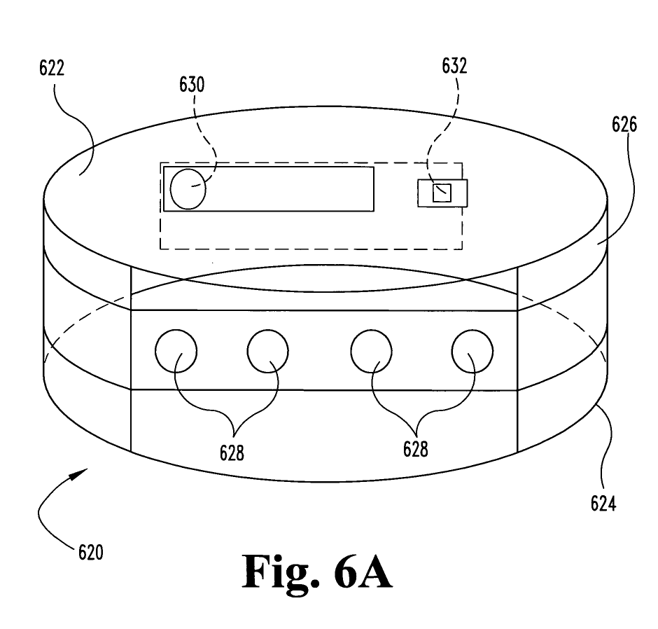

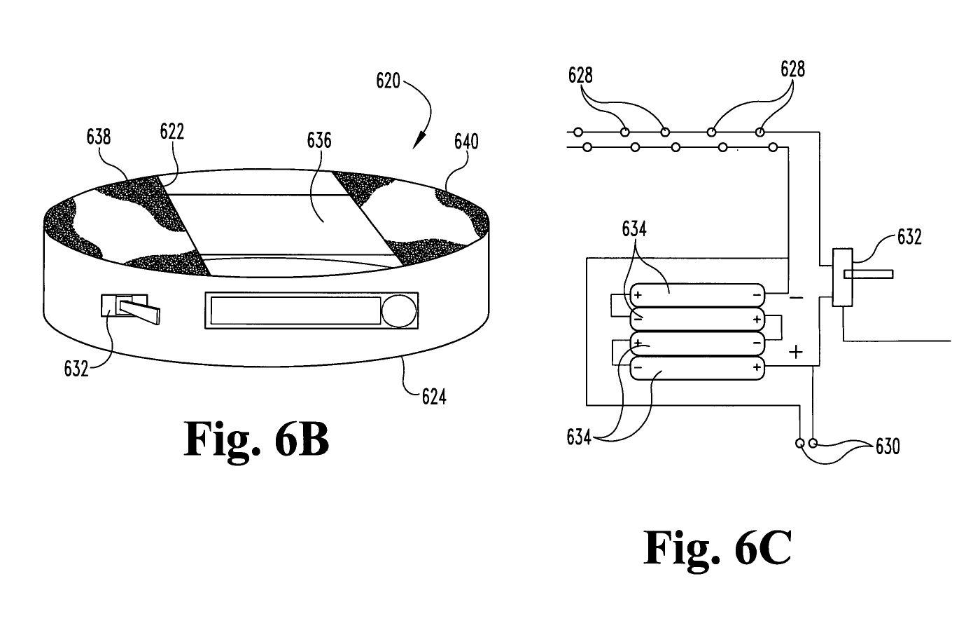

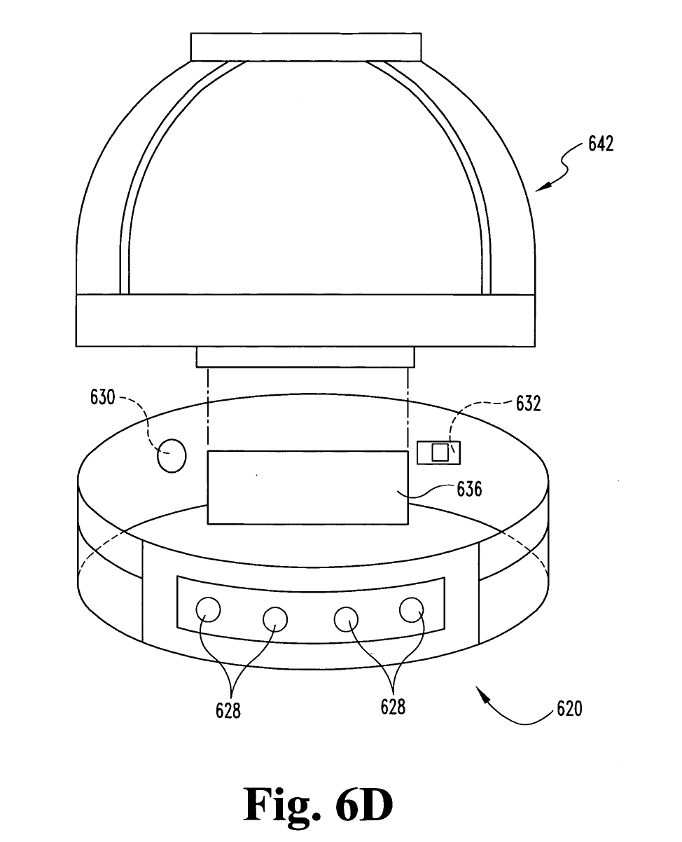

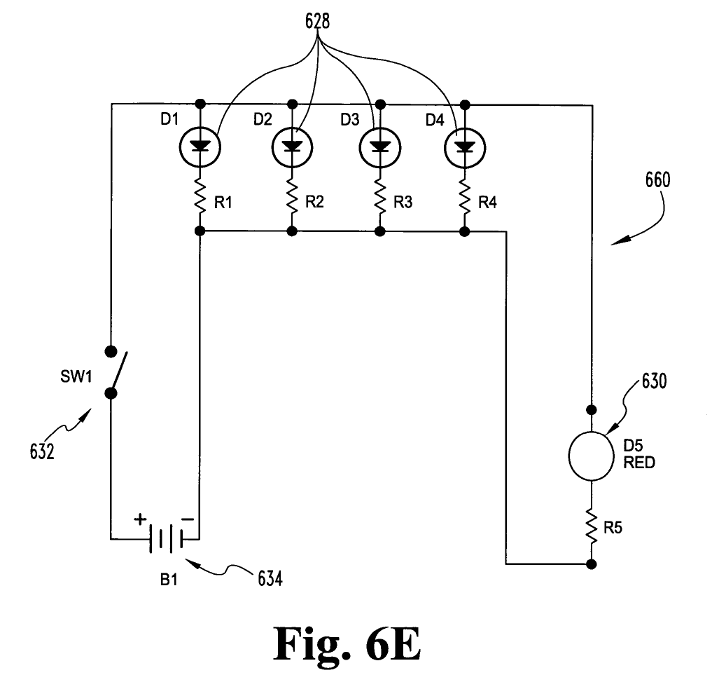

Referring now generally to FIGS. 6A-6D, there is shown a further variation of the embodiment of the device shown in FIGS. 1A-1D. A generally circular (e.g. circular, rounded, oval) container 620 has a top side 622, a bottom side 624, and a circumferential wall 626. A first set of LEDs 628 are on a front portion of circumferential wall 626, and a second set of LEDs 630 are on a rear portion of wall 626. In the illustrated embodiment, LEDs 628 include four white high intensity LEDs such as those described above, and LEDs 630 include one red high intensity LED such as those described above. LEDs 628 and 630 are preferably attached directly to container 620, although it will be appreciated that appropriate electrical connections could be included in or on container 620 to allow a cuff with LEDs attached to it (such as cuff 302 described above) to be wrapped around wall 626 or otherwise attached to container 620 and electrically connected to it.

A switch 632 is also provided. It will have one “off” position and one or more “on” positions, depending on the types of illumination desired, as detailed above. Switch 632 is shown in FIG. 6B to be attached to a rear portion of wall 626, but it will be understood that it could be in other locations on container 620, or could be a remote switch with cable (not shown in FIGS. 6A-6D) extending to container 620. A schematic circuit diagram is shown in FIG. 6C, and includes four AAA batteries 634 connected to switch 632 and LEDs 628 and 630. Batteries 634 are connected to the circuit by conventional battery connections (not shown), and are located inside container 620.

A schematic diagram of one embodiment of a circuit 660 (comparable to that shown in FIG. 6C) that can be used is also shown. It indicates LEDs 628 and 630, battery 634, switch 632, and resistance (shown as R1 through R5). As indicated above, these and other components may be used in known fashion in order to provide energy for substantially continuous illumination or flashing operation, or other operation of LEDs.

An aperture 636 may be provided in the center of container 620 (FIG. 6B). Aperture 636 is shown as roughly square and extending through the entirety of the height of container 620, although it will be appreciated that aperture 636 may have any of a number of regular or irregular shapes and may be shallower than the height of container 620 (i.e. there would be no aperture through bottom side 624 of container 620). Aperture 636 is provided to accommodate a boss, tab, clasp or other mating or locking structure on a horse's tack or other part of an individual conveyance. Top side 622 has two lateral portions 638 and 640 which are covered with hook-and-loop fastener in this embodiment. It will be appreciated that other types of fasteners, such as adhesives, hooks, snaps or the like, could be used in place of such hook-and-loop fastener. FIG. 6D shows schematically the connection of container 620 to a stirrup 642 by inserting a boss 644 on stirrup 642 into aperture 636 of container 620. In this case, boss 644 acts simply as a guide, and stirrup 642 is provided with hook-and-loop fastener (or other appropriate fastener) so that container 620 can be attached to stirrup 642. Boss 644 may be of a hard material (e.g. plastic), or may be of a softer material such as rubber to provide additional sealing ability. Boss 644 can be replaced with a positive engagement, such as a clasp, detent, hook or similar device, to assist with or perform entirely the attachment of container 620 to stirrup 642.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. An apparatus for connection to a horse or horse tack, comprising:
one or more light-emitting diodes;
a power supply; and
a switch enabling turning on and turning off said light emitting diodes.

2. The apparatus of claim 1, wherein said light-emitting diodes each have a color from the set consisting of white, red, blue, yellow and green.

3. The apparatus of claim 2, comprising a first set of light-emitting diodes that emit high-intensity white light, and a second set of light-emitting diodes that emit a high-intensity red light.

4. The apparatus of claim 1, wherein said switch is located relatively remote from said light-emitting diodes.

5. An apparatus comprising:
a container having an opening;
a battery positioned within said container;
a light-emitting diode positioned at least partially in said opening so that light can shine outside of said container;
said light emitting diode being electrically connected to said battery;
a switch electrically connected to said light emitting diode and said battery;
wherein said container can be carried by an individual or a conveyance.

6. The apparatus of claim 5, wherein said container includes a plurality of openings, and comprising a plurality of light-emitting diodes, each of said light-emitting diodes positioned at least partially in a corresponding one of said openings, and wherein said battery and said switch are electrically connected to said plurality of light-emitting diodes.

7. The apparatus of claim 5, further comprising a piece of hook-and-loop material attached to said container adapted to enable connection of said container to a conveyance.

8. The apparatus of claim 7 wherein said conveyance comprises a stirrup, said stirrup having a lower surface, and a second piece of hook-and-loop material attached to said lower surface, whereby said hook-and-loop material attached to said lower surface is capable of mating with said hook-and-loop material attached to said container.

9. An apparatus comprising:
a conveyance including a member with a lower surface;
a container having an upper surface, a generally front area, and a generally rear area, said upper surface being removably attached to said lower surface of said member, said container including a first set of light-emitting diodes, a second set of light-emitting diodes, and a battery, said battery being electrically connected to said first and second sets of light-emitting diodes;
said first set of light-emitting diodes placed in said generally front area of said container so as to be able to shine outside said container, and said second set of light-emitting diodes placed in said generally rear area of said container so as to be able to shine outside said container; and
at least one switch electrically connected to said battery and said first and second sets of light-emitting diodes.

10. The apparatus of claim 9, wherein said member is a stirrup.

11. The apparatus of claim 9, wherein said member is a pedal.

12. The apparatus of claim 9, wherein said lower surface of said member and said upper surface of said container each include a piece of hook-and-loop fastener whereby said member and said container are attached.

13. The apparatus of claim 12, wherein said container includes a seal adjacent said upper surface.

14. The apparatus of claim 9, wherein said first set of light-emitting diodes includes at least one light-emitting diode that is adapted to emit white light.

15. The apparatus of claim 14, wherein said second set of light-emitting diodes includes at least one light-emitting diode that is adapted to emit red light.

16. The apparatus of claim 15, wherein all of said first set of light-emitting diodes is adapted to emit white light, and all of said second set of light-emitting diodes is adapted to emit red light.

17. The apparatus of claim 9, wherein said switch has a setting wherein at least one of said sets of light-emitting diodes flash.

18. The apparatus of claim 9, wherein said lower surface has an area, and said upper surface has an area, and said upper surface area is approximately equal to or less than said lower surface area.

19. The apparatus of claim 9, wherein said switch is located remotely from said container.

20. The apparatus of claim 9, wherein said switch has a non-conducting position and a plurality of conducting positions.
